(19) United States
(12) Patent Application Publication
(10) Pub. No.: US 2006/0268324 A1
(43) Pub. Date: Nov. 30, 2006

(54) Multi-function printer

(75) Inventors: Chia-Chu Cheng, Hsin-Tien (TW); Shih-Chi Cheng, Hsin-Tien (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORP.

(21) Appl. No.: 11/302,474

(22) Filed: Dec. 14, 2005

(30) Foreign Application Priority Data
May 27, 2005 (TW) 94117521

(51) Int. Cl. G06F 3/12

(52) U.S. Cl. 358/1.15

(57) ABSTRACT

A multi-function printer includes a photo module, an output module and a process module. The photo module is used for obtaining at least one image information. The output module is electrically connected with the photo module for outputting the at least one image information obtained by the photo module. The process module is electrically connected with the photo module and the output module for controlling the information process and transition between the photo module, the output module and an external system. The multi-function printer adopts the photo module to replace the scan module of the prior art to obtain the images. Therefore, regardless of the resolution of obtained image, the present invention has a merit of rapidly obtaining the images. Moreover, the photo module also can obtain the images by a three-dimensional method and can be disassembled from the multi-function printer and operated alone as a general digital still camera.

### BACKGROUND OF THE INVENTION

1. Field of the Invention

The present invention relates to a multi-function printer. In particular, a multi-function machine adopts a photo module to obtain images for saving the time of obtaining the images.

2. Description of the Related Art

In the office, the office machines, such as copy machines, fax machines, printers or scanner, are the essential information apparatus. The office machines enhance the quality and the efficiency of the work and also make the storage and management of the files and the file-holder is more convenient and neater. However, the design and the operation method for each of office machines are different. Moreover, because each of office machines occupies a corresponding space, it is a problem for the user when the office space is small.

Therefore, due to the development of the technology and the requirement of the user, the design of the information products has a tendency of multi-function. A multi-function printer (MFP) having multi functions is used to reducing the space occupied by the office machines in the office and enhancing the working efficiency of the user.

Moreover, the integration of the frames and the functions of the multi-function printer means that the structures needs to be collected and rearranged, and it is also necessary to merge and simplify the elements having similar function due to the requirement of small-size. For example, a control chip set of the prior art is used for controlling a single function, such as copy, print, fax or scan etc. Now, the control chip set needs to control all the functions, such as including the CPU module, the image compression and decompression module, the memory control module, and the LCD panel control module etc. Therefore, it is important to integrate the functions.

However, the image-obtaining apparatus of the multi-function printer of the prior art adopts the scan module to obtain the image by a scanning method. Therefore, the user takes a longer time to obtain the image. Especially, when a high-resolution image is obtained, the user needs much longer time to obtain the image.

Furthermore, due to the structure of the fastening mechanism of the scan module of the prior art, the scan module cannot be used for other functions. The scan module of the prior art only can be used for a two-dimensional operation in the multi-function printer, such as printing or scanning the document. It cannot obtain the image from the document by a three-dimensional method, or the scan module cannot be operated alone. The scan module of the prior art cannot be used in different functions.

### SUMMARY OF THE INVENTION

One particular aspect of the present invention is to provide a multi-function printer. The multi-function printer adopts a photo module to replace the scan module of the prior art to obtain the images. Therefore, regardless of the resolution of obtained image, the present invention can rapidly obtain the images to solve the drawback of needing a longer time to obtain the high-resolution images of the prior art. Moreover, the photo module of the present invention also can obtain the images by a three-dimensional method. For example, the photo module can be rotated vertically or horizontally to obtain a two-dimensional or three-dimensional image in different direction or angle. Alternatively, the photo module can be disassembled from the multi-function printer and operated alone as a general digital still camera. Therefore, the present invention has the merit of saving the time for obtaining the image, and the photo module used in the present invention has multi function.

The multi-function printer includes a photo module, an output module and a process module. The photo module is used for obtaining at least one image information. The output module is electrically connected with the photo module for outputting the at least one image information obtained by the photo module. The process module is electrically connected with the photo module and the output module for controlling the information process and transition between the photo module, the output module and an external system.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of the multi-function printer of the present invention.

### DETAILED DESCRIPTION OF THE PREFERRED EMBODIMENTS

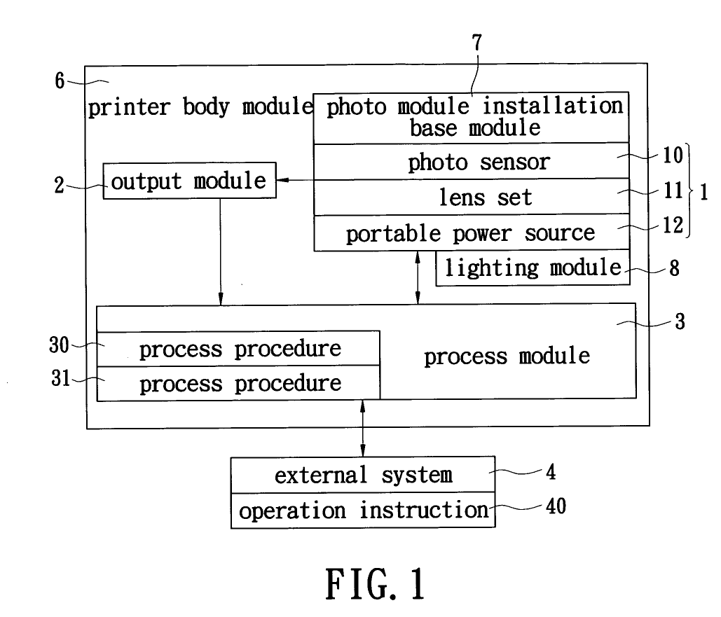

Please refer to FIG. 1, which shows a block diagram of the multi-function printer of the present invention. In the figure, the multi-function printer of the present invention includes a photo module 1, an output module 2 and a process module 3.

The photo module 1 is used for obtaining at least one image information and the at least one image information can be stored, transmitted or printed by the multi-function printer. The output module 2 is electrically connected with the photo module 1 for outputting the at least one image information obtained by the photo module 1. The photo module 1 is a printing device for printing the at least one image information obtained by the photo module 1. Furthermore, the printing device can print the information originally stored in the multi-function printer or the information transmitted from other devices to the multi-function printer.

The photo module 1 includes a photo sensor 10 and a lens set 11 linked with the photo sensor 10. The photo sensor 10 is a CCD photo sensor or a CMOS photo sensor. The lens set 11 can be a zoom lens or a wide view angle lens.

The process module 3 is electrically connected with the photo module 1 and the output module 2 for controlling the information process and transition between the photo module 1, the output module 2 and an external system 4.

The multi-function printer of the present invention further includes a printer body module 6 and a photo module installation base module 7. The photo module 1 is installed on the photo module installation base module 7 and the photo module installation base module 7 is installed on the printer body module 6. Therefore, the photo module 1 is linked with the printer body module 6. The photo module installation base module 7 and the printer body module 6 can be integrated into one piece. The output module 2 and the process module 3 both are installed on the printer body module 6.

Moreover, the height of the photo module installation base module 7 is adjustable to make the height of obtaining the image for photo module 1 is adjustable. Alternatively, the photo module installation base module 7 can be rotated by 360 degrees in the horizontal to make the horizontal angle of obtaining the image for photo module 1 is set according the demand. Moreover, the photo module installation base module 7 can be rotated by 360 degrees in the vertical to make the vertical angle of obtaining the image for photo module 1 is set according the demand. Therefore, the photo module 1 of the present invention can adjust its height or angle according to the requirement of the user via the photo module installation base module 7.

The photo module 1 includes a portable power source 12, and the photo module 1 is detachably installed on the photo module installation base module 7. The portable power source 12 provides the power to the photo module 1 to make the photo module 1 can be operated alone after the photo module 1 is detached from the photo module installation base module 7. Alternatively, the photo module 1 can be installed on the photo module installation base module 7 via a locking method for prevent the photo module 1 from being stolen.

Furthermore, the multi-function printer of the present invention further includes a lighting module 8 installed on the photo module 1 or the printer body module 6. The lighting module 8 is a lighting element that its brightness can be adjusted.

The process module 3 builds in a process procedure 30 for receiving the operation instruction 40 of the external system 4. Therefore, the process module 3 executes the corresponding operation instruction 40 of the external system 4 via controlling the information transition between the photo module 1, the output module 2 and an external system 4. The external system 4 is a computer. Alternatively, the process module 3 builds in a predetermined process procedure 31. Therefore, the process module 3 executes the image-obtaining, data transmitting, printing and/or storing set by predetermined process procedure 31 via controlling the information transition between the photo module 1, the output module 2 and an external system 4.

Furthermore, the process procedure 30, 31 has a preset continuous photo mode, including the period and the number of continuous photo capturing. Alternatively, the process procedure 30, 31 has a photo function adjusting mode for executing the photo module, including adjusting the range of obtaining image, adjusting the height, the horizontal rotation angle and the vertical rotation angle of the photo module. The photo function adjusting mode further includes a zooming function and an auto-focus function.

Moreover, the process procedure has an image process function for processing the at least one image information, and the image process function at least comprises rotating the image, enhancing the image quality and compressing the image.

The process procedure 30, 31 has an image process function for processing the at least one image information. The image process function includes rotating the image, enhancing the image quality and compressing the image.

However, the described process procedure 30, 31 is not used for limiting the scope of the present invention. All programs or procedures that can be applied at the multi-function printer having the photo module 1 are protected by the present invention.

The present invention adopts a photo module to replace the scan module of the prior art to obtain the images. Therefore, regardless of the resolution of obtained image, the present invention can rapidly obtain the images to solve the drawback of needing a longer time to obtain the high-resolution images of the prior art. Moreover, the photo module of the present invention also can obtain the images by a three-dimensional method. For example, the photo module can be inverted vertically or rotated horizontally to obtain a plane or three-dimensional image in different direction or angle. Alternatively, the photo module can be disassembled from the multi-function printer and operated alone as a general still camera. Therefore, the present invention has the merit of saving the time for obtaining the image, and the photo module used in the present invention has multi function.

The description above only illustrates specific embodiments and examples of the invention. The invention should therefore cover various modifications and variations made to the herein-described structure and operations of the invention, provided they fall within the scope of the invention as defined in the following appended claims.

1-28. (canceled)

29. A multi-function printer, comprising:
a photo module used for obtaining at least one image information;
an output module electrically connected with the photo module for outputting the at least one image information obtained by the photo module; and
a process module is electrically connected with the photo module and the output module for controlling the information process and transition between the photo module, the output module and an external system.

30. The multi-function printer as claimed in claim 29, wherein the at least one image information is stored, transmitted or printed by the multi-function printer.

31. The multi-function printer as claimed in claim 29, wherein the output module is a printing device for printing the at least one image information obtained by the photo module.

32. The multi-function printer as claimed in claim 31, wherein the printing device is used for printing the information originally stored in the multi-function printer or the information transmitted from other device to the multi-function printer.

33. The multi-function printer as claimed in claim 29, wherein the photo module comprises a photo sensor and a lens set linked with the photo sensor.

34. The multi-function printer as claimed in claim 33, wherein the photo sensor is a CCD photo sensor.

35. The multi-function printer as claimed in claim 33, wherein the photo sensor is a CMOS photo sensor.

36. The multi-function printer as claimed in claim 33, wherein the lens set is a photo zoom lens.

37. The multi-function printer as claimed in claim 33, wherein the lens set is a wide view angle lens.

38. The multi-function printer as claimed in claim 29, further comprising a printer body module and a photo module installation base module; wherein the photo module is installed on the photo module installation base module and the photo module installation base module is installed on the printer body module to make the photo module is linked with the printer body module.

39. The multi-function printer as claimed in claim 38, wherein the output module and the process module are installed at the printer body module.

40. The multi-function printer as claimed in claim 38, further comprising a lighting module located at the photo module or the printer body module.

41. The multi-function printer as claimed in claim 40, wherein the lighting module is a lighting element that its brightness is adjustable.

42. The multi-function printer as claimed in claim 38, wherein the photo module installation base module and the printer body module are integrated into one piece.

43. The multi-function printer as claimed in claim 38, wherein the height of the photo module installation base module is adjustable to adjust the height of obtaining image for the photo module.

44. The multi-function printer as claimed in claim 38, wherein the photo module installation base module is capable of rotating with 360 degrees horizontally to make the horizontal angle of obtaining image for the photo module is capable of setting according to the demand.

45. The multi-function printer as claimed in claim 38, wherein the photo module installation base module is capable of rotating with 360 degrees vertically to make the vertical angle of obtaining image for the photo module is capable of setting according to the demand.

46. The multi-function printer as claimed in claim 38, wherein the photo module includes a portable power source and is detachably installed at the photo module installation base module; thereby, the photo module is operated alone when the photo module is detached from the photo module installation base module.

47. The multi-function printer as claimed in claim 38, wherein the photo module is installed at the photo module installation base module by a locking method.

48. The multi-function printer as claimed in claim 29, wherein the process module builds in a process procedure for receiving the operation instruction of the external system to make the process module executes the corresponding operation instruction of the external system via controlling the information transition between the photo module, the output module and an external system.

49. The multi-function printer as claimed in claim 29, wherein the process module builds in a predetermined process procedure to make the process module executes the image-obtaining, data transmitting, printing and/or storing set by predetermined process procedure via controlling the information transition between the photo module, the output module and an external system.

50. The multi-function printer as claimed in claim 48, wherein the process procedure has a preset continuous photo mode, including the period and the number of continuous photo capturing.

51. The multi-function printer as claimed in claim 49, wherein the process procedure has a preset continuous photo mode, including the period and the number of continuous photo capturing.

52. The multi-function printer as claimed in claim 48, wherein the process procedure has a photo function adjusting mode for executing the photo module, including adjusting the range of obtaining image, adjusting the height, the horizontal rotation angle and the vertical rotation angle of the photo module.

53. The multi-function printer as claimed in claim 49, wherein the process procedure has a photo function adjusting mode for executing the photo module, including adjusting the range of obtaining image, adjusting the height, the horizontal rotation angle and the vertical rotation angle of the photo module.

54. The multi-function printer as claimed in claim 51, wherein the photo function adjusting mode further comprises an automatic zooming function and an automatic focusing function.

55. The multi-function printer as claimed in claim 48, wherein the process procedure has a parameter adjustment starting function and a parameter adjustment sequence starting function.

56. The multi-function printer as claimed in claim 49, wherein the process procedure has a parameter adjustment starting function and a parameter adjustment sequence starting function.

57. The multi-function printer as claimed in claim 53, wherein the parameter adjustment at least comprises the color mode, the height, the horizontal rotation angle, the vertical rotation angle, the range of obtaining image, the center of obtaining image, the focus adjustment and the automatic focusing of the photo module.

58. The multi-function printer as claimed in claim 48, wherein the process procedure has an image process function for processing the at least one image information.

59. The multi-function printer as claimed in claim 49, wherein the process procedure has an image process function for processing the at least one image information.

60. The multi-function printer as claimed in claim 55, wherein the image process function at least comprises rotating the image, enhancing the image quality and compressing the image.
